(19) United States
(12) Patent Application Publication
(10) Pub. No.: US 2018/0322583 A1
(43) Pub. Date: Nov. 8, 2018

(54) Child Support Benefit Policies Service

(71) Applicant: Gwendolyn M. Eubanks, Elgin, IL (US)

(72) Inventor: Gwendolyn M. Eubanks, Elgin, IL (US)

(21) Appl. No.: 15/584,152

(22) Filed: May 2, 2017

(51) Int. Cl. G06Q 40/08; G06Q 10/10; G06Q 50/26

(52) U.S. Cl. CPC G06Q 40/08; G06Q 90/00; G06Q 50/26; G06Q 10/10

(57) ABSTRACT

A child support benefit policies service for protecting the financial well-being of families who are guardians of children under a current child support order. The child support benefit polices generally include family relationships, insurance, risk mitigation and the court system.

### BACKGROUND OF THE INVENTION

### Field of the Invention

The present invention relates generally to family assets recoveries and more specifically it relates to a child support benefit policies service for protecting the financial well-being of families who are guardians of children under a current child support order.

### SUMMARY OF THE INVENTION

The invention generally relates to a family assets recovery which includes family relationships, insurance, risk mitigation and the court system.

There has been thus outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a child support benefit policies service for protecting the financial well-being of families who are guardians of children under a current child support order.

Another object is to provide a Child Support Benefit Policies service that provides child support continuation in the event of default by the non-custodial parent or guardian.

Another object is to provide a Child Support Benefit Policies Service that focuses on the financial needs of the children.

Another object is to provide a Child Support Benefit Policies Service that includes a risk mitigation system to reduce overall costs and maintain higher profits.

Another object is to provide a Child Support Benefit Policies Service that provides both human and technological interfaces to aid the client in providing necessary documentation to qualify for insurance and to obtain policy payouts when necessary.

Other objects and advantages of the present invention will become obvious to the reader and is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features, and attendant advantages of the present invention will become fully appreciated as the same becomes better understood when considered in conjunction with the accompanying drawings, wherein:

FIG. 1 is a front view of the present invention. Diagram 1: Child Support diagram—Child Support Court Order. The diagram shows how custodial orders are developed through the court system.

FIG. 2 is a front view of the present invention. Diagram 2: Child Support Diagram Default. This diagram shows how default on payment required by court order occurs.

FIG. 3 is a front view of the present invention. Flowchart 1: Initiation of Service Process. This flowchart shows the process by which a client initiates a child support protection insurance.

FIG. 4 is a front view of the present invention. Flowchart 2: Procedural Initiation Process. This process shows how a representative (either an individual or a company) would make sure the potential client had the necessary court documents to proceed with the process outlined in Flowchart 1.

FIG. 5 is a front view of the present invention. Flowchart 3: Evidentiary Service Process. This flowchart shows the process of billing and servicing the client.

FIG. 6 is a front view of the present invention. Flowchart 4: Service Process Incorporating a Court Order. This flow chart describes the process of including the cost of the insurance by amending the court order.

FIG. 7 is a front view of the present invention. Flowchart 5: Cancellation and Reinstatement of Policies. This flow chart shows what happens when a client stops paying the premiums for the policy and how the policy can be reinstated.

FIG. 8 is a front view of the present invention. Flowchart 6: Default/Restore Process. This flow chart shows what happens when the non-custodial parent/guardian stops paying and what actions need to be taken to restore the payments.

FIG. 9 is a front view of the present invention. Flowchart 3a: Case Management Process. This is a subset of Flowchart 3 showing how a new client is initiated into the case management process.

FIG. 10 is a front view of the present invention. Diagram 3: General Website Page. This diagram shows the general website page the public will see. This part of the website is for marketing, advertising and information.

FIG. 11 is a front view of the present invention. Diagram 4: Secure, Specific Website Page for Existing Clients. This diagram shows how a new client is registered and once accepted, the various resources and account information to which the client will have access.

### DETAILED DESCRIPTION OF THE PREFERRED EMBODIMENT

### A. Overview

Turning now descriptively to the drawings, in which similar reference characters denote similar elements throughout the several views, the figures illustrate family relationships, insurance, risk mitigation and the court system.

### B. Children

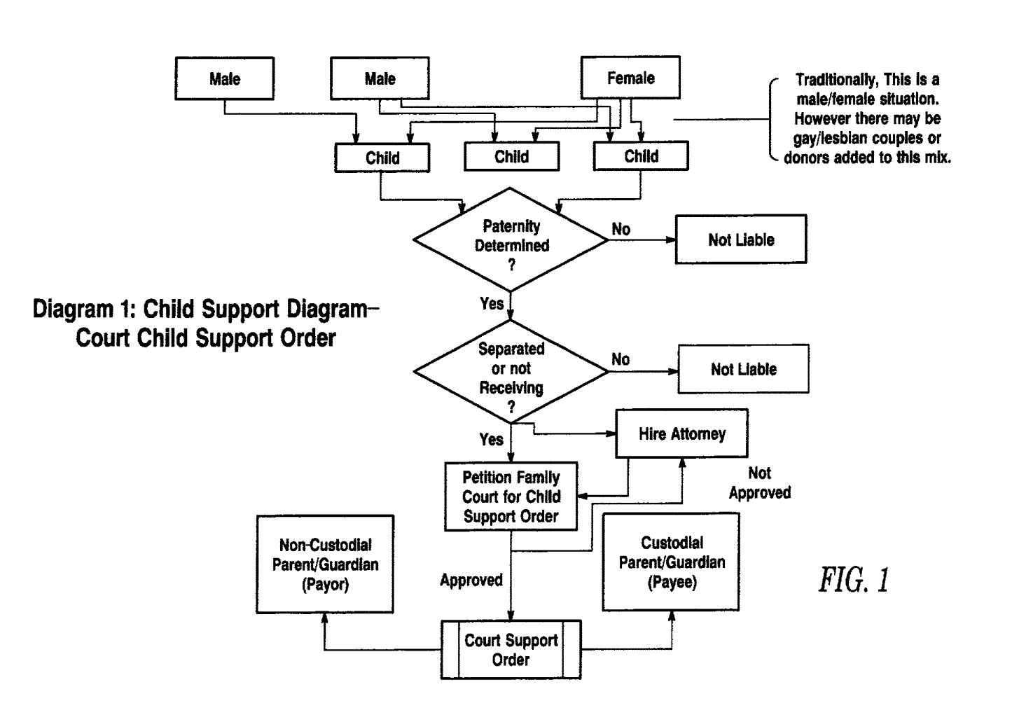

A key element of this patent is the welfare of the child, needs of the child and standard of living for the child. Involved in the child's life is the guardian, custodial or non-custodial parent (see FIG. 1). When the relationship ends, the court grants a custodial parent or guardian the right to raise the child and receive child support from the non-custodial parent or guardian. A court order spells out these conditions and is legally binding until amended, cancelled, or the child is emancipated.

The children are the underage dependents (biological children, step-children, or adopted children) of the custodial parent or guardian (payee) and non-custodial parent(s) (payor). The amount of payment for child support depends on the parent's standard of living for the child. This is determined by the court order and is different depending on the payee and payor's financial situations. These financial situations may be impacted by factors, not limited to but including: multiple children from the non-custodial parent and other individuals besides the client; the child's health or well-being; accidents or other emergency issues; and emancipation of the child or age of the child.

### C. Insurance

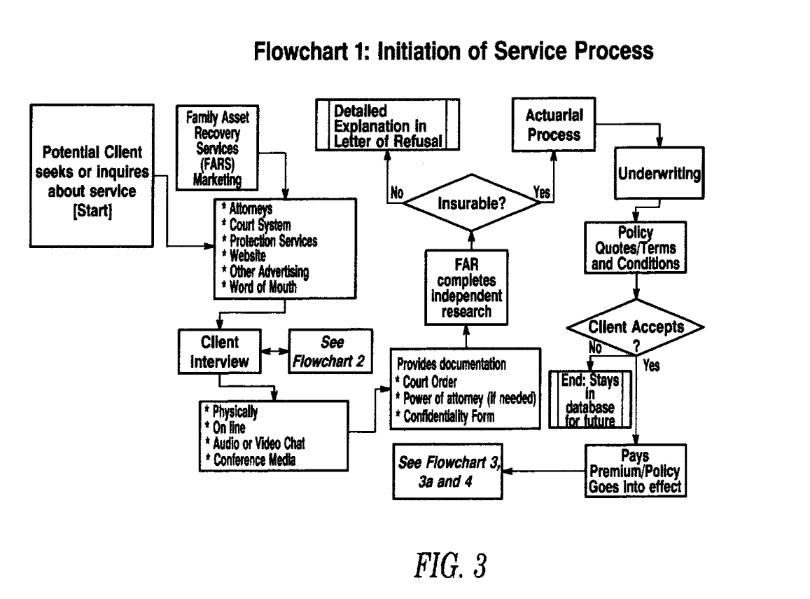

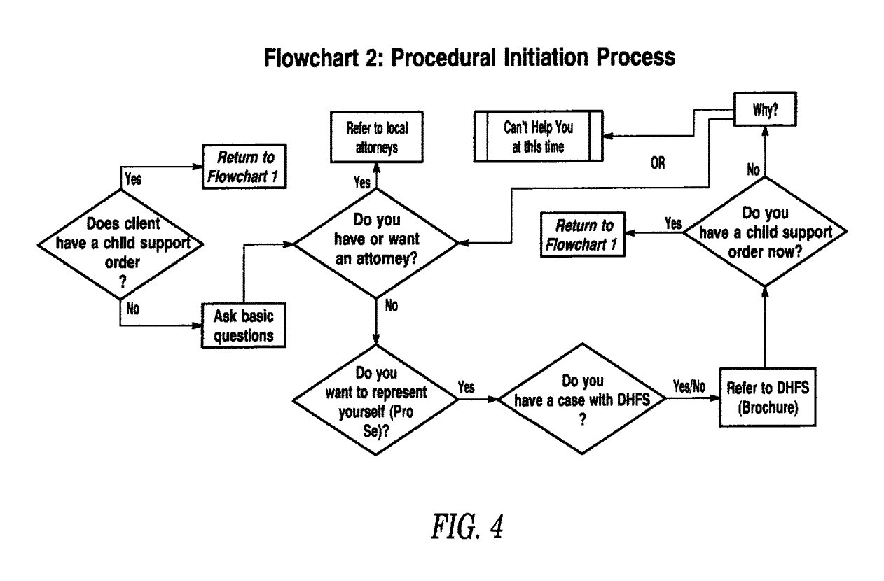

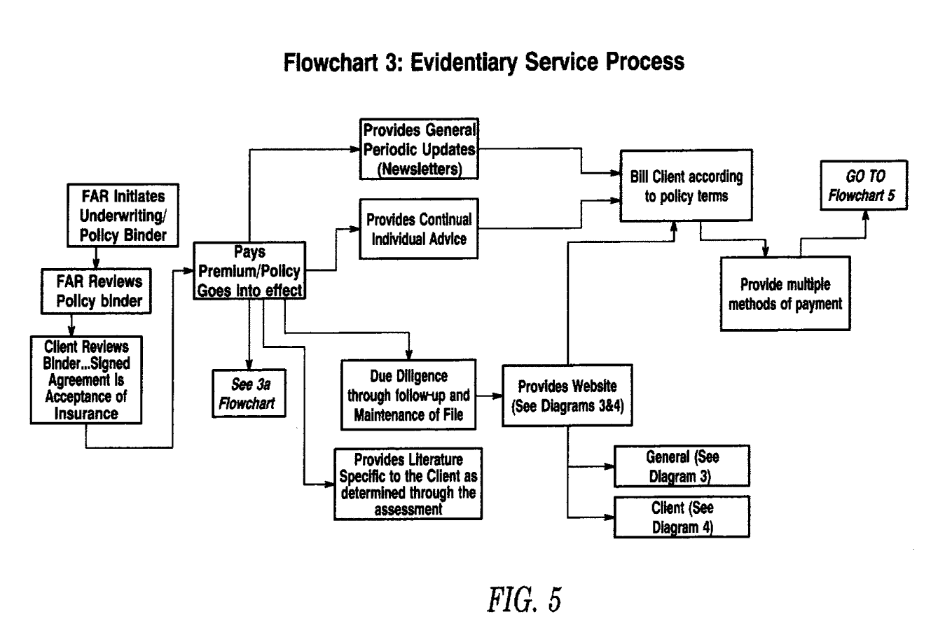

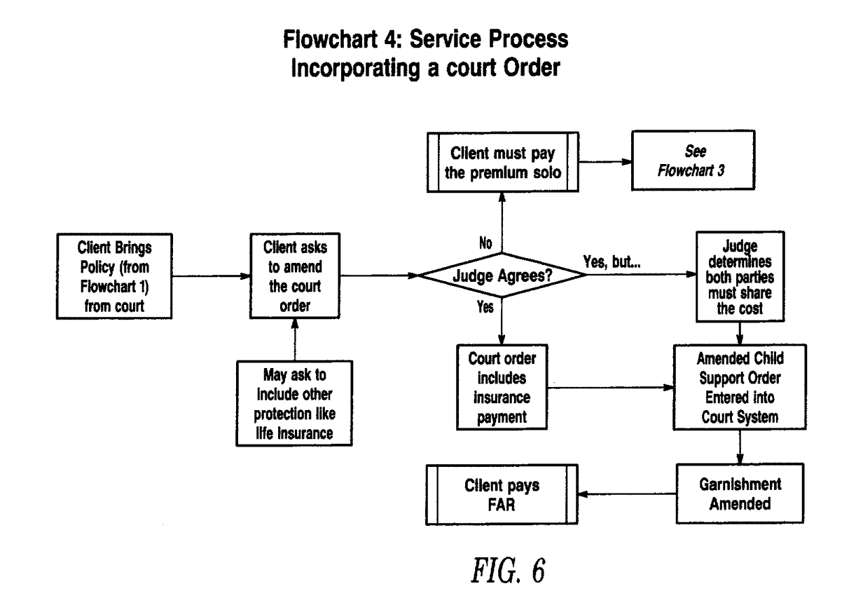

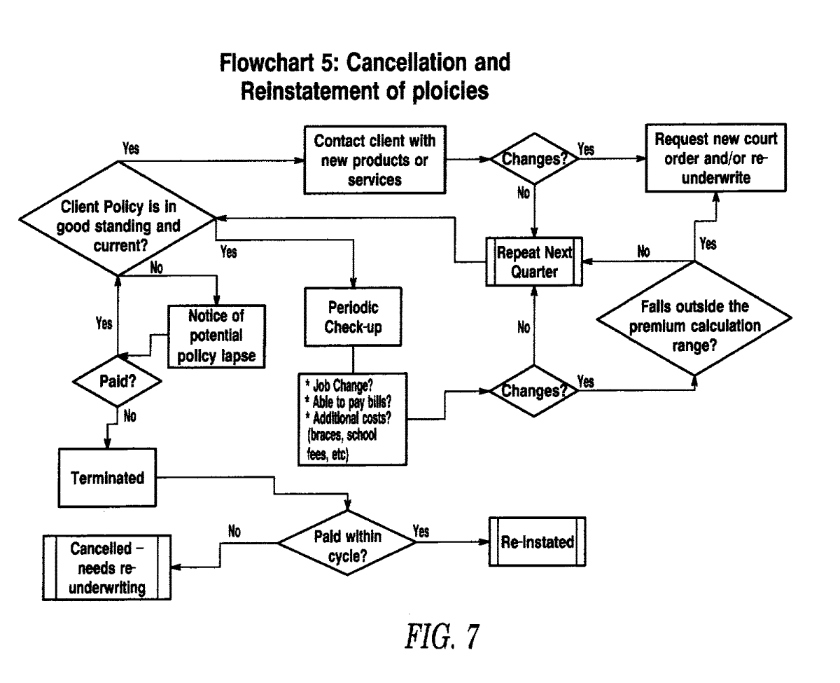

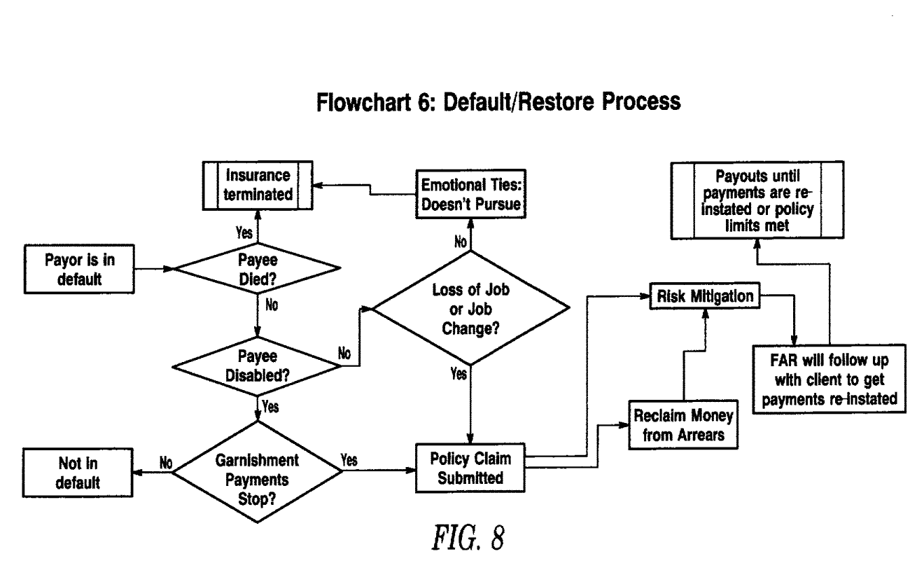

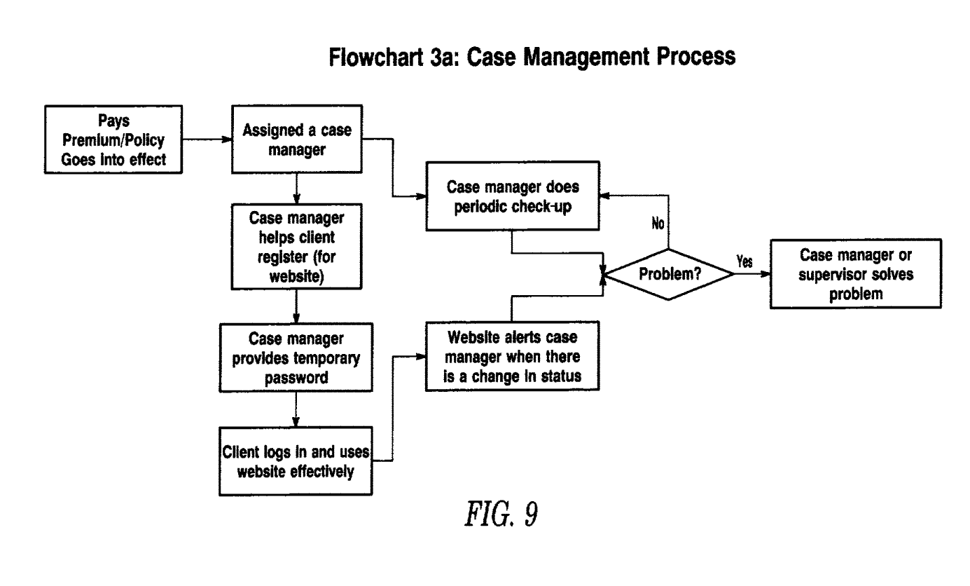

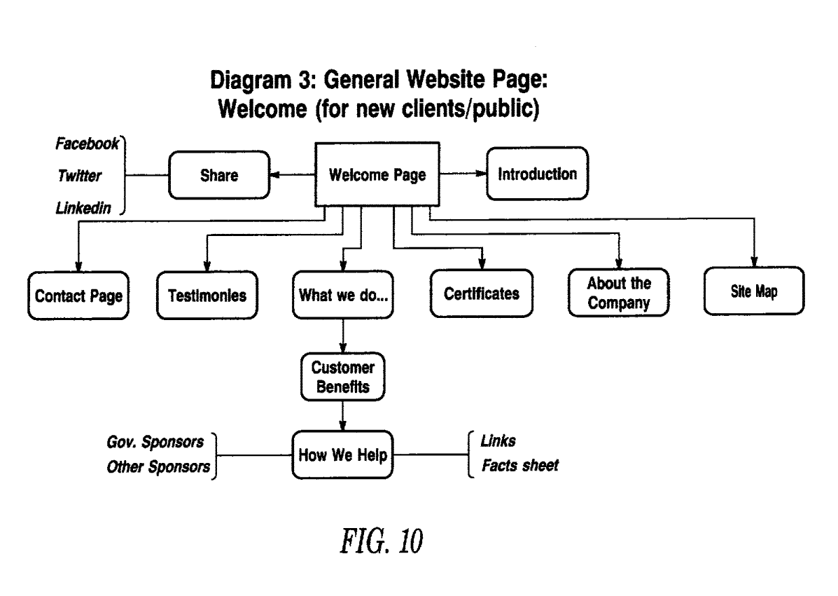

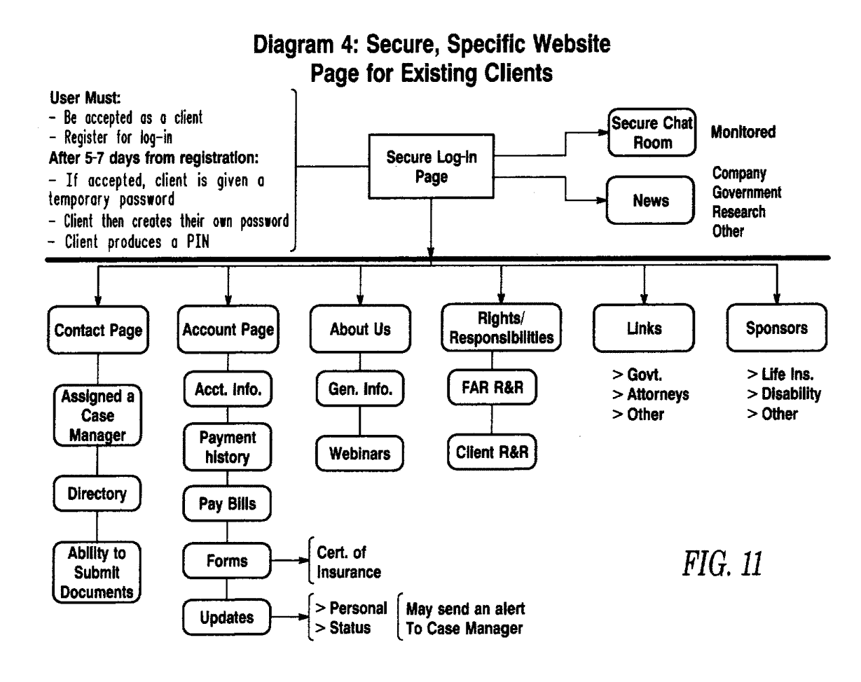

A key element of this patent is providing child support insurance through Family Assets Recovery Company (FIGS. 3-9 illustrate how Family Assets Recovery initiates, maintains, reinstates, and/or cancels the service it provides). Other services would include advocating for children, obtaining actuarial services from an insurance company or insurance brokers, and providing other types of insurance such as life, short term and long term disability. FIG. 3 shows how the client attempts to initiate service with Family Assets Recovery. FIG. 4 shows how Family Asset Recovery may need to help the client obtain the necessary documentation before their policy can be underwritten. FIG. 5 shows how once the client has been accepted and the policy approved by the client, the service is underwritten, billed, maintained and serviced. FIG. 9 shows the Case Management process and FIGS. 10 and 11 show how a client may use the website to initiate services and the website services available once the client has been accepted by Family Asset Services. FIG. 6 shows how a client can amend the child support court order to include the fees for this insurance along with other types of insurance that the child may need to protect the family's assets. FIG. 7 shows the process when the client stops payment and the policy is cancelled along with the other reinstatement processes. FIG. 8 shows the process that occurs when the non-custodial parent/guardian (the payor) stops the policy payments. This includes the process used to restore the payments and insurance payouts.

The basis of financial recovery insurance is to protect the assets of the custodial parent and child(ren) in the event of a default or loss of child support income so that the child(ren)'s standard of living is comparable to the state prior to loss or default. Family Assets Recovery will need to maintain a financial reserve or insurance policy to provide for pay-outs to the custodial parent/child in the event of default or loss. Family Assets Recovery will need to have actuarial services and establish risk management policies that will result in contracts with terms, conditions and responsibilities and policies that both the custodial parent or guardian and Family Assets Recovery will sign upon acceptance. Also, Family Assets Recovery will provide other types of insurance, such as life or disability insurance, as the carrier if possible, but if necessary through another carrier.

This insurance can be a supplement to life insurance for custodial or non-custodial parent(s), guardian(s), or child(ren). The policy may entail lump sum benefit payment for the child(ren) upon the death of either parent or guardian, or other financial investment options. This insurance policy can be converted to an investment product.

### D. Court System

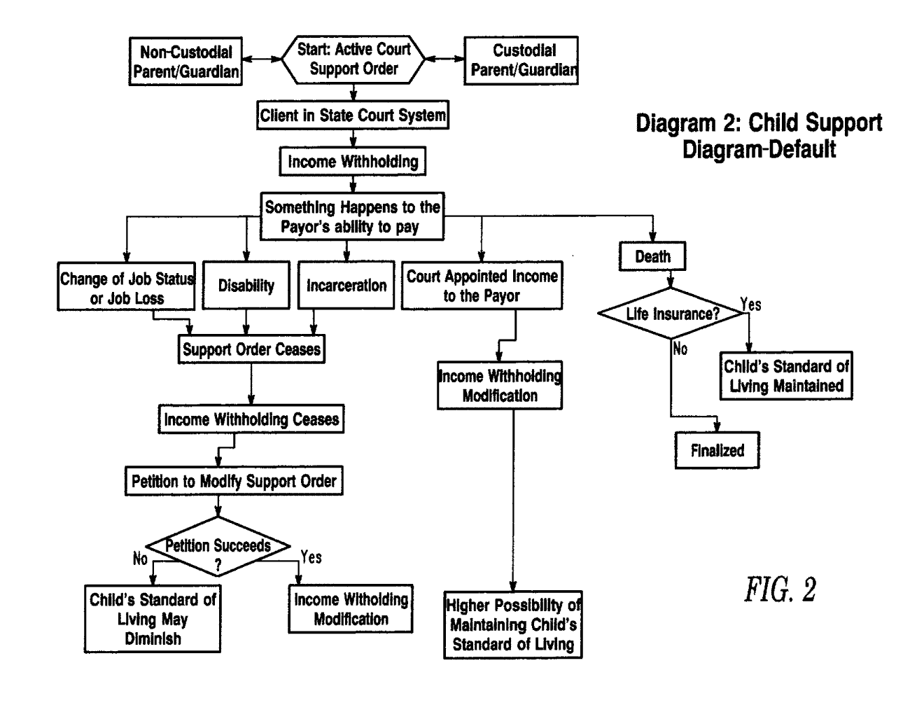

Another key element of this patent is the court system that provides court orders such as child support orders. Also attorneys and private investigators provided necessary services. Other advocates can also provide necessary services as well. FIGS. 1 and 2 illustrate the key importance of the court in producing and amending the court order, along with other court services, such as finding the non-custodial parent when the non-custodial parent is in default and garnishments have ceased.

The court system provides the legal means to protect the assets of the child(ren) and custodial parent(s) or guardian(s). Additionally, the Department of Healthcare and Family Services, attorneys, and private investigators provide necessary services. The court will determine the financial needs of the child(ren) and will provide the terms of the court order. The court order provides the documentation of those requirements and the responsibilities of both non-custodial parent(s) and custodial parent(s) or guardian(s) towards the welfare of the child(ren). The court order will also provide terms and limitations. Child Support Enforcement Services provides legal actions to reinstate the court requirements if the non-custodial parent(s) default(s) in payment. In some cases, the State Attorney's office will act in lieu of Child Support Enforcement Services. The custodial parent(s) or guardian(s) can either represent themselves, or use another party, such as an attorney.

Different state child support enforcement laws include financial guidelines. Court systems vary by judge, court opinion, and interpretations of various laws or ordinance (local court rules, deadlines, appearance dates, right to delay process, etc.).

### E. Risk Mitigation

Another key element of this patent application is to identify and prevent risks in the delivery of the financial support described above. Risks occur mainly when the payee is in default of payment. FIGS. 3-9 illustrate the various risk mitigation tasks such as upfront due diligence and underwriting (FIGS. 3-4), attempting to include the premium payments in the court order (FIG. 6), the maintenance of the service (FIGS. 5-7) and advocacy during default by payor (FIG. 8).

### F. Technology Link

Another key element of this patent application is to provide a link for clients to contact, learn about services, exchange documents, and be able to link to other resources. FIGS. 10-11 illustrate how the potential client can access information about the insurance, send documents, and contact a case manager. FIG. 9 shows the case management process once the client is accepted. FIG. 11 shows how the client signs into the secure website and the resources available once the client logs into secure website.

Potential clients are introduced to the services provided by Family Asset Recovery by a combination of case managers, the general website (see FIG. 10) and other technology. Once the client has been accepted and has paid their first premium, the client is registered onto the secure client website page (see FIG. 11). The secure client website provides access to account information, resource links, and file transfer capabilities. The website could also include links to “about the company,” insurance, document upload and download, letters and other correspondence in the case, as well a means of contacting a case manager.

Possible variations could include web links to the court system, attorneys, other state, county or municipal departments that provide services to custodial parents and child support. Other web links for web services could be other forms of insurance and services.

### G. Case Management

Another key element of this patent is to provide case management services for each new client. This is a subset of the evidentiary service for a new client. FIG. 9 shows how the case management process works. The case manager assists and advocates for the client and at the same time provides risk management services for the organization.

Once the client is accepted and pays their first payment, they are assigned to a case manager. FIG. 9 outlines the case management process from helping the new client to register to follow-up and problem solving with the client. The case manager is also the person the client contacts if the non-custodial parent has defaulted in their child support payments.

Functional variations of the case management process includes assisting the client with multiple support orders (e.g., children with different fathers), working with the court to include the cost of the insurance as a part of the child support order, providing educational services to assist the client or potential clients with information about services that would be helpful to the client or potential client.

### H. Connections of Main Elements and Sub-Elements of Invention

The custodial parent or guardian establishes paternity of the non-custodial parent. The custodial parent or guardian receives a court order from the family court. The custodial parent or guardian is concerned with default in the payment as stated in the court order. The custodial parent or guardian applies for insurance to maintain the standard of living for the child(ren). Family Asset Recovery (FAR) completes research and assessment and completes due diligence in order to offer a policy or a policy contingent on other requirements. FAR provides the custodial parent or guardian with a payout schedule based on the timeframe of payment and a policy with terms and conditions. FAR must maintain financial reserves to ensure payout and uses actuarial services to maintain the schedule of payouts and the risk analysis of each client. Once the client begins payment FAR will follow up with a periodic due diligence and offer other insurance or investment opportunities to the client. A Case Manager is assigned to the potential client and assists the client when they are approved. This includes helping the client sign on to the website for the first time. The Case Manager assists the client with problems and issues, does periodic status checks, and seeks referrals. The potential client uses the website to obtain information and links to other services, is assisted by the Case Manager with the initial login. The client can then use the website for a variety of information including forms such as certificate of insurance, account information, making premium payments, and general information and education on the child support system. The client applies for insurance to maintain the standard of living for the child(ren). When the non-custodial parent(s) default(s) in payment due to death, disability, voluntary or involuntary job loss, change of job, reduction in pay or modification of court order, FAR will pay out according to the policy through the case management analysis and schedule of payments. FAR will work with the custodial parent or guardian, as well as the attorney(s), State Child Support Enforcement Services, Private Investigators, State Attorneys, or other advocates for child support, to reinstate the court required payments.

### I. Alternative Embodiments of Invention

1st Alternative Variation is converting the product from insurance to an investment option.

2nd Alternative Variation is providing variations on policy due to multiple policies, e.g., multiple children from different non-custodial parents.

3rd Alternative Variation is that this insurance becomes standard insurance offered by insurance companies (like life insurance companies).

4th Alternative Variation is that this insurance becomes standard insurance offered by courts or federal, state, and local governments, or included in the child support order.

5th Alternative Variation is this insurance can be a pre-tax deductible insurance offered by organizations or by state/county agencies.

6th Alternative Variation is this product can work similar to Supplemental Security Income (SSI) benefits in that the claims could be paid out and maintained similar to how SSI claims are paid out to children, parents or guardian.

### J. Operation of Preferred Embodiment

A child(ren) is/are conceived. The parent(s) and/or guardian establish paternity. The child(ren) establish its/their standard of living. This may include a medical condition, special schooling, etc. The parents separate or divorce, or the non-custodial parent stops financially supporting the child(ren), and the custodial parent/guardian seeks child support or is referred by state agencies to seek a child support order. The custodial parent or guardian may seek an attorney, private investigator, another advocate for child support, or appeal to the family court on their own behalf.

The custodial parent or guardian obtains a child support order. The support order is then sent to the employer of the non-custodial parent, or the non-custodial parent is required to submit payment to the court or state disbursement unit (may vary by state). Non-custodial parents who receive disability, social security, unemployment compensation may have those funds garnished as well.

The custodial parent or guardian may feel a need to purchase insurance to protect the child(ren)'s standard of living. The custodial parent or guardian may do a web search or be referred to the general website by advertising or referral. The custodial parent or guardian fills out the paperwork to start the pre-policy due diligence and research. The client may be able to submit documentation through the website and is assigned a Case Manager. During the assessment, the custodial parent/guardian will be questioned to determine how much they know of the child support process. The custodial parent or guardian may seek the Department of Healthcare and Family Services, an attorney, and/or a private investigator. Family Asset Recovery provides the necessary research to determine what other type of insurance would be helpful in maintaining the child(ren)'s standard of living such as life, short-term, and long-term disability, or they may access it through the general website.

Once all necessary steps are completed, and actuarial services are used, the policy is underwritten to establish policy costs, a policy can be purchased. The purchase establishes an active insurance policy to protect the assets of the financial income provided by court support order. Once regular payments have been established, the policy is in effect and the Case Manager will assist the client in logging into the secure log-in page. A chart showing payments over time and the maximum payout limits will be provided in policy. Family Asset Recovery will provide continuous due diligence to make sure that the custodial parent is actively engaged in their roles and responsibilities listed in the policy such as modifications of court support order, job changes, address changes, etc. Also at this time, the policy holder can be asked for referrals. Adherence to the policy terms is critical in controlling the payout of benefits. Each policy will receive a risk management review to make sure the policy is still categorized within the proper risk category (e.g., low, medium, or high). If the risk category changes, it may be necessary to change the premium's monthly cost.

Through the secure website, the client may obtain information about their account, access documents (like certificate of insurance), pay online, and obtain information about child support laws and regulations as well as other information.

When there has been a default of child support (due to death, disability, loss of job, emotional tie to payee, job change, etc.), the terms of the policy will be enforced. Policy terms and the number of payments made, will determine the length of payouts from insurance. During this time all parties have roles and responsibilities to adhere to according to the provision in the policy. Services from the Case Manager, State Attorney, State Child Enforcement Services, or Department of Healthcare and Family Services will be used to find the non-custodial parent or reinstate or modify the court support order. Either the non-custodial parent is found and the child support is restored, or, the child support order is modified by the court and a new policy is underwritten, or the policy has reached its maximum support.

What has been described and illustrated herein is a preferred embodiment of the invention along with some of its variations. The terms, descriptions and figures used herein are set for by way of illustration only and are not meant as limitations. Those skilled in the art will recognize that many variations are possible within the spirit and scope of the invention in which all terms are meant in their broadest, reasonable since unless otherwise indicated. Any heading utilized within the description are for convenience only and have no legal or limiting effect.

I claim:

1. A method of reducing the risk of loss of financial support to at least one child, who is the subject of a court order mandating support, comprising:
collecting pertinent information from at least one custodial parent or guardian;
entering such information into a database designed to produce a policy;
formulating at least one policy for the at least one custodial parent or guardian, on behalf of at least one affected child;
entering into an agreement with the at least one custodial parent or guardian as to the at least one policy;
receiving payment for said policy from the at least one custodial parent or guardian;
reporting said policy to Family Asset Recovery;
maintaining contact with the at least one custodial parent or guardian in regards to the policy;
terminating said policy if and or when a lapse of coverage occurs;
reinstating said policy where applicable; and
notifying Family Asset Recovery and affiliated personnel of changes to the status of the policy.

2. The method of claim 1, wherein:
the affiliated personnel include at least one member selected from the following class:
Family Asset Recovery social worker,
Family Asset Recovery case manager,
Department of Healthcare and Family Services,
government and private employers;
Child Support Enforcement Services;
State District Courts;
attorneys;
Social Security Administration;
non-profit organizations;
insurance carriers;
co-insurance companies; and
underwriters.

3. A method of monitoring the status of a child support order, comprising:
creating an electronic system;
registering accepted clients for access to said electronic system;
requiring accepted clients to utilize password protection in order to access said electronic system;
uploading copies of relevant documentation to said electronic system;
allowing for updates of documentation and information by authorized parties;
restricting access to said electronic system to parties directly involved with each client's case;
allowing clients to view information relevant to their cases;
providing clients with outside resources relevant to their cases; and
allowing a restricted class of personnel to access the electronic system.

4. The method of claim 3, wherein the restricted class of personnel comprises at least one of the following:
Family Asset Recovery and its associates;
Family Asset Recovery's appointed case managers;
Department of Healthcare and Family Services;
Child Support Enforcement Services;
State District Courts;
government and private employees;
attorneys;
Social Security Administration;
non-profit organizations;
insurance carriers;
underwriters; and
co-insurance companies.

5. A method of ensuring financial support for children through an integrated process, wherein there is at least one non-custodial parent and at least one custodial party, and at least one active court order establishing the terms of child support payments, comprising:
incorporating a risk management program, whereby the at least one affected child is protected against loss due to non-payment of child support by the at least one non-custodial parent.

6. The method of claim 5, further comprising:
a case manager assigned by Family Asset Recovery to monitor and manage the progression of the case and to facilitate compliance with the court order; and
said case manager being apprised of the risk management program and capable of advising the at least one custodial party as to how to utilize said program in order to benefit the at least one affected child.

7. The method of claim 5, wherein:
the risk management program is an investment account.

8. The method of claim 5 wherein:
the risk management program is an insurance policy.

9. The method of claim 5, further comprising:
An electronic system to allow the at least one non-custodial parent to access updates and information, monitor the status of financial support for the at least one affected child, and access resources necessary to ensure continued financial support for the at least one affected child.

10. The method of claim 9, further comprising:
a case manager assigned by Family Asset Recovery;
said case manager having access to the electronic system; and
said case manager utilizing the electronic system to communicate with the at least one non-custodial parent regarding the court order and financial support.

11. The method of claim 5, wherein:
multiple risk management programs may exist concurrently, to account for a plurality of affected children.

12. The method of claim 5, wherein:
at least some of the cost of the risk management program is incorporated into the amount of financial support outlined in the court order.

13. The method of claim 4, further comprising:
collecting information from at least one of the members of the restricted class of personnel.

14. The method of claim 3, further comprising:
the electronic system allowing a subscriber to upload to the electronic system; and
the electronic system allowing a subscriber to download from the electronic system.

15. The method of claim 1, wherein:
the at least one policy is transferrable.

16. The method of claim 1, wherein:
the at least one policy may be adjusted if the underlying court order is modified.

17. The method of claim 1, wherein:
the at least one policy is underwritten to include termination of the court order due to incarceration.

18. The method of claim 1, wherein:
the at least one policy is underwritten to include termination of the court order due to disability.

19. The method of claim 1, wherein:
the at least one policy is underwritten to include termination of the court order due to a change in employment circumstances.
